(19) United States
(12) Patent Application Publication
(10) Pub. No.: US 2013/0302563 A1
(43) Pub. Date: Nov. 14, 2013

(54) POLYMERIZABLE COMPOSITION AND OPTICAL SHEET COMPRISING CURED RESIN LAYER FORMED THEREFROM

(71) Applicants: Hong Gu Hwang, Incheon (KR); Kyung Jong Kim, Yongin-si (KR); Chang Won Park, Yongin-si (KR); Eui Young Shin, Seongnam-si (KR); Chang Pyo Hong, Yongin-si (KR)

(72) Inventors: Hong Gu Hwang, Incheon (KR); Kyung Jong Kim, Yongin-si (KR); Chang Won Park, Yongin-si (KR); Eui Young Shin, Seongnam-si (KR); Chang Pyo Hong, Yongin-si (KR)

(73) Assignee: KOLON INDUSTRIES, INC., Gwacheon-si, Gyeonggi-do (KR)

(21) Appl. No.: 13/880,618

(22) PCT Filed: Oct. 20, 2011
(86) PCT No.: PCT/KR2011/007832

§ 371 Date: Jun. 28, 2013

(30) Foreign Application Priority Data
Oct. 20, 2010 (KR) 10-2010-0102295
Oct. 20, 2010 (KR) 10-2010-0102297

(51) Int. Cl. F21V 11/16

(52) U.S. Cl. CPC F21V 11/16
USPC 428/141; 428/195.1; 428/704; 526/241; 528/271; 522/183

(57) ABSTRACT

The present invention relates to a photopolymerizable composition and an optical sheet comprising a cured resin layer formed therefrom. The polymerizable composition shows a high refractive index and excellent light resistance and is thus useful for an optical sheet assembly for a backlight unit.

### TECHNICAL FIELD

The present invention relates, in general, to a photopolymerizable composition and an optical sheet having a cured resin layer formed therefrom, and more particularly to a photopolymerization composition, the reaction of which is initiated by light to form a cured resin layer, and to an optical sheet, such as a prism sheet, which has a cured resin layer formed therefrom.

### BACKGROUND ART

In the development of an optical sheet for a backlight unit, efforts have been made to condense light emitted from a light source and control the direction of the light to improve front luminance. If a three-dimensional structure is used which can suitably change the interference, diffraction, polarization and photon phenomena of light having both wave properties and particle properties, the flow of light can be controlled, and if the physical properties of a material forming the this three-dimensional structure are changed, the flow of light can be further controlled. In these cases, the user can control the direction of the emission of light to the desired direction to improve luminance in that direction.

Meanwhile, in the physical properties of an optical sheet, properties associated with an enhancement in luminance include a refractive index. The higher the refractive index, the better is the performance of the optical sheet.

Typical examples of a resin having a high refractive index, which can form a three-dimensional structure on an optical sheet, include photocurable resins containing a halogen atom substituent such as bromine in the polymer chain.

Meanwhile, in recent years, leading countries, including European Union (EU) members, have enacted environmental regulations that restrict the trade of products containing environmentally hazardous substances, and established environmental standards that limit their import and are, in fact, used as non-tariff barriers.

Environmentally friendly product designs and cleaner production technologies that consider contamination factors and recycling barriers (which can occur during all processes, including production, use and disposal) starting from the product design stage have been regarded as essential requirements for ensuring the competitiveness and survival of enterprises.

In view of this tendency, an optical sheet having a photocurable resin layer containing a halogen atom substituent such as bromine in the polymer chain falls short in terms of satisfying environmental regulations. Particularly, halogen atoms are known to cause environmental hormones, and thus in European countries sensitive to environmental issues, the use of halogen-free products is being positively recommended.

Meanwhile, in the case of a transparent optical sheet having a prism structure, the rate of an increase in luminance varies depending on the refractive index of a resin forming the prism resin. Generally, as the refractive index of the resin forming the prism structure increases, the rate of increase in luminance increases. Thus, research and development have taken place in order to increase the refractive index of the resin.

Generally, the resin forming the prism structure is made of an organic compound, and the upper limit of the refractive index range controllable by the organic compound is known to be about 1.7, indicating that the controllable refractive index is narrower than that controllable by an inorganic compound. A high-refractive-index resin consisting of only an organic compound has problems, including increased viscosity and low UV stability, which significantly limits the use thereof. Therefore, there is an urgent need for the research and development of a prism composition exhibiting a significantly increased luminance.

### DISCLOSURE OF INVENTION

### Technical Problem

Accordingly, the present invention has been made keeping in mind the above problems occurring in the prior art, and an object of the present invention is to provide a photopolymerizable composition suitable for forming a cured resin layer having a high refractive index.

Another object of the present invention is to provide an optical sheet comprising a cured resin layer having high refractive index.

Still another object of the present invention is to provide a composite optical sheet comprising a cured resin layer having high refractive index.

### Solution to Problem

In order to accomplish the above object, according to a first preferred aspect of the present invention, there is provided a photopolymerizable composition comprising one or more of organometallic compounds represented by the following formulas 1 and 2:

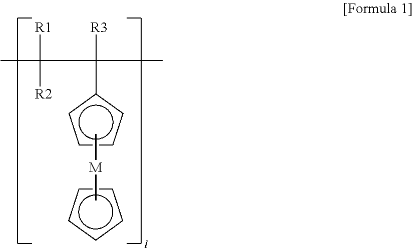

wherein R₁ to R₃ are the same or different and represent a hydrogen atom or an alkyl group having 1 to 15 carbon atoms, M is a metal atom selected from the group consisting of Fe, Mn, Sn, Ti, Si, Cr and Co, and 1 is an integer of 2 or more; and

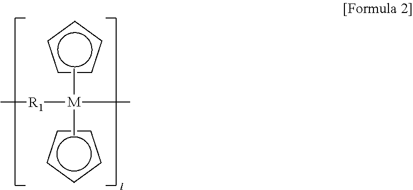

wherein R1 is an organic group containing at least one atom selected from the group consisting of a hydrogen atom, a carbon atom, an oxygen atom and a nitrogen atom, M is a metal atom selected from the group consisting of Fe, Mn, Sn, Ti, Si, Cr and Co, and 1 is an integer of 2 or more.

According to a second preferred aspect of the present invention, there is provided a photopolymerizable composition comprising an organic/inorganic composite prepared from a metal alkoxide represented by the following formula 3 and an organic compound capable of forming a chemical bond with M of formula 3:

M(OCₙH₂ₙ₊₁)₄ [Formula 3]

wherein M is a transition metal, and n is an integer ranging from 1 to 1000.

In the present invention, the organic compound may be selected from the group consisting of carboxylic acids, β-ketoesters and β-diketones, which may form a chelate bond with the metal ion M.

In the present invention, the organic compound may be selected from the group consisting of stearic acid, oleic acid, 10-undecylenic acid, acetoacetoxyethyl-methacrylate (AAEM) and allyl acetoacetate (AAA).

In the present invention, the photopolymerizable composition may further comprise at least one UV-curable monomer, at least one photoinitiator, and at least one additive.

According to a third preferred aspect of the present invention, there is provided an optical sheet comprising a substrate layer and a cured resin layer formed on one side of the substrate layer, wherein the cured layer may comprise said photopolymerizable composition.

In the above aspect, the surface of the cured resin layer may have a structured shape in which a plurality of three-dimensional structures are linearly or non-linearly arranged.

In the above aspect, the cured resin layer may have a light diffusion layer formed on the surface thereof.

In the above aspect, the cured resin layer may have a refractive index of 1.54 to 2.0.

According to a fourth preferred aspect of the present invention, there is provided a backlight unit assembly comprising at least one layer consisting of said optical sheet.

### BRIEF DESCRIPTION OF DRAWINGS

FIG. 1 is a schematic view of an organic/inorganic composite prepared from a metal alkoxide and an organic compound according to the present invention.

### BEST MODE FOR CARRYING OUT THE INVENTION

Hereinafter, the present invention will be described in further detail.

The present invention relates to a photopolymerizable composition comprising one or more of organometallic compounds represented by the following formulas 1 and 2:

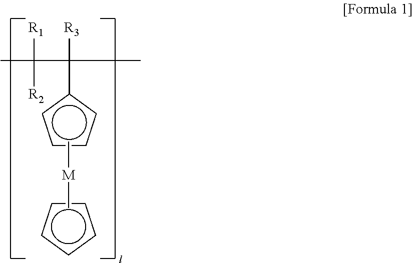

wherein R₁ to R₃ are the same or different and represent a hydrogen atom or an alkyl group having 1 to 15 carbon atoms, M is a metal atom selected from the group consisting of Fe, Mn, Sn, Ti, Si, Cr and Co, and 1 is an integer of 2 or more; and

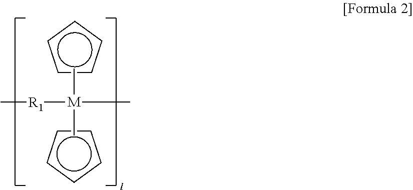

wherein R₁ is an organic group containing at least one atom selected from the group consisting of a hydrogen atom, a carbon atom, an oxygen atom and a nitrogen atom, M is a metal atom selected from the group consisting of Fe, Mn, Sn, Ti, Si, Cr and Co, and 1 is an integer of 2 or more.

The present invention also relates to a polymerizable composition comprising an organic/inorganic composite prepared from a metal alkoxide represented by the following formula 3 and an organic compound capable of forming a chemical bond with M of formula 3:

M(OCₙH₂ₙ₊₁)₄ [Formula 3]

wherein M is a transition metal, and n is an integer ranging from 1 to 1000.

Specifically, M may be a transition metal selected from among Zr, Ti and Hf.

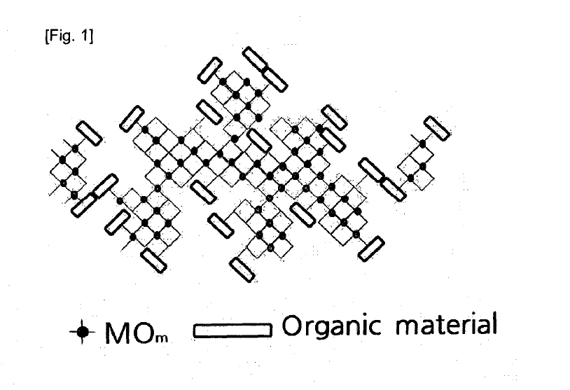

Referring to FIG. 1, in the organic/inorganic composite, a metal oxide (MOm) portion and an organic material portion are chemically bonded to each other, and the metal oxide portion may be amorphous or crystalline. The metal oxide portion exhibits the effect of increasing the refractive index of the organic/inorganic composite. Also, the organic material portion may comprise a reactive group that can improve the compatibility of the UV-curable composition and form a chemical bond with other organic materials, in which the reactive group may be an acrylate group, a vinyl group or the like.

Specifically, the organic compound that is used in the present invention may be any organic compound having a reactive group capable of forming a chemical bond with the transition metal M of formula 3, and the organic/inorganic composite may be prepared by chemical bonding between the metal alkoxide represented by formula 3 and the organic compound.

The organic compound may be selected from among carboxylic acids, β-ketoesters and β-diketones, which can form a chelate bond with the metal ion. More specifically, the organic compound may be selected from among stearic acid, oleic acid, 10-undecylenic acid, acetoacetoxyethylmethacrylate (AAEM) and allyl acetoacetate (AAA).

Either the photopolymerizable composition comprising one or more of the organometallic compounds represented by formulas 1 and 2 or the photopolymerizable composition comprising the organic/inorganic composite prepared from the metal alkoxide represented by formula 3 and the organic compound capable of forming a chemical bond with M of formula 3 may also comprise various UV-curing monomers, photoinitiators and additives, and may be used to a cured resin layer.

Either the photopolymerizable composition comprising one or more of the organometallic compounds represented by formulas 1 and 2 or the photopolymerizable composition comprising the organic/inorganic composite prepared from the metal alkoxide represented by formula 3 and the organic compound capable of forming a chemical bond with M of formula 3 can be cured to provide a cured resin layer having a high refractive index of 1.54 to 2.0. In addition, the compositions have excellent heat resistance and abrasion resistance, and thus are suitable for forming a cured resin layer for an optical sheet.

In the photopolymerizable composition comprising one or more of the organometallic compounds represented by formulas 1 and 2, the content of one or more of the organometallic compounds represented by formulas 1 and 2 can be suitably controlled depending on the refractive index or luminance properties required for the cured resin layer, but it is preferably 5-90 wt % based on the total solid content of the photopolymerizable polymer in terms of improving luminance.

In the photopolymerizable composition comprising the organic/inorganic composite prepared from the metal alkoxide represented by formula 3 and the organic compound capable of forming a chemical bond with M of formula 3, the content of the organic/inorganic composite prepared from the metal alkoxide can also be suitably controlled depending on the refractive index or luminance properties required for the cured resin layer, but it is preferably 1-99.9 wt % based on the total solid content of the photopolymerizable polymer in terms of improving luminance.

To form a cured resin layer, the photopolymerizable composition as described above may further comprise at least one UV-curable monomer which may advantageously have a refractive index of 1.44 or higher at 25° C. If the refractive index of the UV-curable monomer is excessively high, it can increase the viscosity of the composition to excessively increase the surface hardness of the cured resin layer, and if the refractive index is excessively low, the refractive index of the resulting optical sheet may be reduced, making it difficult to achieve high luminance. Specifically, the UV-curable monomer(s) may have a refractive index of 1.44 to 1.60 at 25° C.

When the composition does not contain or contains a UV-curable monomer having a viscosity of 1 to 50,000 cps at 25° C. and/or a refractive index of 1.44 or higher at 25° C., it can advantageously have a viscosity of 10 to 10,000 cps at 25° C. Also, the viscosity at 25° C. of the composition can influence not only the processability of the composition, but also the surface hardness of the resulting coated resin layer and the compressive strain of the resulting optical sheet. Thus, if the viscosity of the composition is excessively high, the cured resin layer may become brittle, and the viscosity of the composition is excessively low, so that the refractive index of the cured resin layer can be reduced.

Thus, if the composition contains a UV-curable monomer(s) having 1 to 50,000 cps at 25° C., the content of the monomer within this range is preferably controlled in view of the viscosity of the composition.

In addition, the content of the UV-curable monomer may more preferably be such that the refractive index of the composition is 1.54 or higher, in view of the resulting cured resin layer. Specifically, the content of a UV-curable monomer(s) may be an amount such that the refractive index of the composition is 1.54-2.0.

A UV-curable monomer that may be used in the present invention is not specifically is not specifically limited, so long as it satisfies the above-described conditions of refractive index and viscosity. Examples thereof include tetrahydroperfurylacrylate, 2-(2-ethoxyethoxy)ethylacrylate, 1,6-hexanedioldi(meth)acrylate, benzyl(meth)acrylate, phenoxyethyl(meth)acrylate, phenoxy-polyethyleneglycol(meth)acrylate, 2-hydroxy-3-phenoxypropylacrylate, neopentylglycolbenzoate acrylate, 2-hydroxy-3-phenoxypropylacrylate, phenylphenoxyethanolacrylate, caprolactone(meth)acrylate, nonylphenolpolyalkyleneglycol(meth)acrylate, butanediol(meth)acrylate, bisphenol A polyalkyleneglycol-di(meth)acrylate, polyalkyleneglycol-di(meth)acrylate, trimethylpropane tri(meth)acrylate, styrene, methylstyrene, phenylepoxy(meth)acrylate, alkyl(meth)acrylate, and bisphenol F ethyleneglycol di-acrylate.

From various points of view, the composition may advantageously have a refractive index of 1.54 or higher at 25° C. and a viscosity of 1 to 50,000 cps at 25° C., in order to satisfy the surface hardness of the cured resin layer, the compressive strain of the optical sheet, refractive index and the like. Specifically, the composition may have a refractive index of 1.54 to 2.0 at 25° C.

The composition for forming the cured resin layer may comprise a photoinitiator for initiating the photopolymerization of either at least one of the organometallic compounds represented by formulas 1 and 2 or the organic/inorganic composite prepared from the metal alkoxide represented by formula 3 and the organic compound, with the UV-curable monomer(s), but is not limited thereto. Examples of the photoinitiator that may be used in the present invention include phosphine oxide, propanone, ketone, formate, etc.

In addition, the composition may, if necessary, comprise additives, including but not limited to a UV absorber and a UV stabilizer. Also, the composition may further comprise an antistatic agent.

The optical sheet according to the present invention can be advantageous as an optical sheet for improving luminance, if the cured resin layer formed thereon has a refractive index of particularly 1.54 or higher. Specifically, the refractive index at 25° C. of the cured resin layer may be 1.54 to 2.0.

Particularly, in terms of avoiding the generation of hazardous substances, the cured resin layer of the optical sheet according to the present invention is preferably substantially free of halogen. In view of this point, selecting a UV-curable monomer or an additive while keeping environmental protection in mind will be advantageous.

The optical sheet according to the present invention may comprise a substrate layer and a cured resin layer formed by curing the photopolymerizable composition on one side of the substrate layer.

The resin forming the substrate layer of the optical sheet according to the present invention is not specifically limited. In view of transparency, the substrate layer may be, but is not limited to, a film made of polyethylene terephthalate, polycarbonate, polypropylene, polyethylene, polystyrene or polyepoxy resin. Preferably, it may be a polyethylene terephthalate film or a polycarbonate film. The thickness of the substrate layer may advantageously be about 10-1,000 μm in view of mechanical strength, thermal stability, film flexibility and preventing the loss of transmitted light.

Particularly, the surface of the cured resin layer may have a structured shape in which a plurality of three-dimensional structures are linearly or non-linearly arranged.

In one embodiment of the present invention, a method for manufacturing an optical sheet, the surface of which has a structured shape in which a plurality of three-dimensional structures are arranged, may comprise the steps of: preparing a composition either comprising at least one of organometallic compounds represented by formulas 1 and 2 together with a photoinitiator or comprising an organic/inorganic composite prepared from a metal alkoxide represented by formula 3 and an organic compound together with a photoinitiator; applying the composition to a frame having three-dimensional structures engraved thereon; bringing one side of a transparent substrate film into contact with the composition applied to the engraved frame, irradiating the contacted composition with UV light, thereby forming a cured resin layer; and separating the cured resin layer from the engraved frame.

In the step of preparing the composition, at least one UV-curable monomer having a viscosity of 1 to 50,000 cps at 25° C. may be added to control viscosity and the refractive index.

In the case of preparing a composition comprising a halogen-free crosslinkable derivative and at least one UV-curable monomer having a viscosity of 1 to 50,000 cps, controlling the refractive index of the composition to 1.54 or higher and the viscosity of the composition to 10 to 10,000 cps is advantageous in terms of not only the compressive strain of the resulting optical sheet, but also the surface hardness.

Meanwhile, the structured shape of the surface of the cured resin layer can vary depending on the shape of the three-dimensional structures engraved on the frame. Specifically, the structured shape of the surface of the cured resin layer may be a polyhedral shape which is polygonal, semicircular or semielliptical in cross section; a columnar shape which is polygonal, semicircular or semielliptical in cross section; or a curved columnar shape which is polygonal, semicircular or semielliptical in cross section. Alternatively, the structured shape may also be a shape comprising one or more of the above shapes. Moreover, examples of the structured shape also include a case having at least one concentrically arranged structure when seen from the top of the cured resin layer while having a structure in which peaks and valleys are formed along the concentric circle.

In addition, an optical sheet according to another embodiment of the present invention may be an optical sheet comprising a substrate layer, a cured resin layer formed from the photopolymerizable composition on one side of the substrate layer, the surface of the cured resin layer having a structured shape, and a light diffusion layer formed on the surface of the cured resin layer. In this case, the need to combine a plurality of optical sheets with each other can be eliminated, and in addition, the luminance of the optical sheet can be improved and white lines resulting from the structured shape of the surface of the optical sheet can be controlled.

### MODE FOR THE INVENTION

Hereinafter, the present invention will be described in further detail with reference to Examples, but the scope of the present invention is not limited to these Examples.

### Comparative Examples 1 and 2 and Examples 1 to 10

Photopolymerizable compositions were prepared per the components and contents shown in Tables 1 to 3 below. Each of the prepared compositions was applied, according to a conventional method, to a frame engraved with three-dimensional structures (prism layer) having the function of improving luminance. Then, one side of a transparent substrate film (PET film) was brought into contact with the composition applied to the engraved frame, and in this state, the applied composition was photocured by irradiation with UV light. Then, the transparent substrate film having the cured resin layer applied thereto was separated from the transparent substrate film, thereby manufacturing prism films comprising the cured resin layer formed on one side of the transparent substrate film.

The above UV irradiation was carried out by irradiating 900 mJ/cm² of UV light from an electrodeless UV lame (600 W/inch; Fusion Corp., USA) equipped with a type-D bulb.

Although the compositions shown in Tables 1 to 3 below were composed of either the organometallic compound or the organic/inorganic composite together with the UV-curable monomer and the photoinitiator, it will be obvious to a person skilled in the art that such compositions in Tables 1 to 3 are only examples presented to confirm the effect of either the compounds represented by formulas 1 and 2 or the compound represented by formula 3 on refractive index and may comprise other components and additives.

The compositions of the Examples above were evaluated in the following manner.

(1) Refractive Index of Composition

The refractive index of the composition according to each of the Examples was measured at 25° C. using a refractometer (Model: 1T, ATAGO ABBE, Japan). The light source used for the measurement of the refractive index was a D-light sodium lamp of 589.3 nm.

(2) Refractive Index of Cured Coating Layer Formed From Composition

In order to measure the refractive index of the compositions after curing, each of the compositions was applied to a PET film, after which a smooth metal plate was placed on the surface of the applied composition and then pressed down such that the thickness of the applied composition reached a thickness of 20 μm. Subsequently, using an electrodeless UV lamp (600 W/inch; available from Fusion Corp., USA) equipped with a type-D bulb, 700 mJ/cm2 of UV light was irradiated onto the PET film, followed by removing the metal plate. The refractive index of the PET film having the cured composition formed thereon was measured at 25° C. using a refractometer (model: 1T, ATAGO ABBE, Japan). A light source used for the measurement of the refractive index was a D-light sodium lamp of 589.3 nm.

TABLE 1

| | | Comp. | | | |
|---|---|---|---|---|---|
| | | Ex. 1 | Ex. 1 | Ex. 2 | Ex. 3 |
| Organometallic | Compound | — | R₁, R₂, R₃ = H1 = | R₁, R₂, R₃ = H1 = | R₁, R₂, R₃ = H1 = |
| compound | of formula 1 | | 100M = Fe | 1,000M = Fe | 10,000M = Fe |
| | Content | — | 40 | 40 | 40 |
| | (wt %) | | | | |
| UV-curable | Bifunctional | R712 (bisphenol F ethyleneglycol | | | |
| monomer | acrylate | diacrylate; Nippon Kayaku Co., Ltd) | | | |
| | Content | 99.5 | 59.5 | 59.5 | 59.5 |
| | (wt %) | | | | |

| | | | | |
|---|---|---|---|---|
| Photoinitiator (wt %) | 0.5 | 0.5 | 0.5 | 0.5 |
| Refractive index of | 1.540 | 1.572 | 1.575 | 1.574 |
| composition (25° C.) | | | | |
| Refractive index of | 1.561 | 1.595 | 1.599 | 1.598 |
| coating layer (25° C.) | | | | |

*photoinitiator: 2,4,6-trimethylbenzoyl diphenol phosphine oxide

TABLE 2
Table

| | | Ex. 4 | Ex. 5 | Ex. 6 |
|---|---|---|---|---|
| Organometallic | Compound of | R₁ = C₆H₄O₂l = | R₁ = C₆H₄O₂l = | R₁ = C₆H₄O₂l = |
| compound | formula 2 | 100M = Ti | 1,000M = Ti | 10,000M = Ti |
| | Content (wt %) | 40 | 40 | 40 |
| UV-curable | Bifunctional | R712 (bisphenol F ethyleneglycol diacrylate; | | |
| monomer | acrylate | Nippon Kayaku Co., Ltd) | | |
| | Content (wt %) | 59.5 | 59.5 | 59.5 |

| | | | |
|---|---|---|---|
| Photoinitiator (wt %) | 0.5 | 0.5 | 0.5 |
| Refractive index of composition | 1.572 | 1.575 | 1.571 |
| (25° C.) | | | |
| Refractive index of coating layer | 1.591 | 1.595 | 1.593 |
| (25° C.) | | | |

*photoinitiator: 2,4,6-trimethylbenzoyl diphenol phosphine oxide

TABLE 3

| | | Comp. | | | | |
|---|---|---|---|---|---|---|
| | | Ex. 2 | Ex. 7 | Ex. 8 | Ex. 9 | Ex. 10 |
| Organic/inorganic | Compound of | — | M = Tin = 1 | M = Tin = 1 | M = Tin = 1 | M = Zrn = 1 |
| composite | formula 3 | | | | | |
| | Content | 0 | 40 | 40 | 40 | 40 |
| | (wt %) | | | | | |
| | Organic | — | Stearic | Acetoactoxy | Allyl acetoacetate | Acetoacetoxy |
| | compound | | Acid | ethylmethacrylate | | ethyl- |
| | | | | | | methacrylate |
| | Content | 0 | 5 | 5 | 5 | 5 |
| | (wt %) | | | | | |
| UV-curable | Bifunctional | R712 (bisphenol F ethyleneglycol diacrylate; | | | | |
| monomer | acrylate | Nippon Kayaku Co., Ltd) | | | | |
| | Content | 99.5 | 54.5 | 54.5 | 54.5 | 54.5 |
| | (wt %) | | | | | |

| | | | | | |
|---|---|---|---|---|---|
| Photoinitiator (wt %) | 0.5 | 0.5 | 0.5 | 0.5 | 0.5 |
| Refractive index of composition | 1.543 | 1.591 | 1.592 | 1.595 | 1.587 |
| (25° C.) | | | | | |
| Refractive index of coating | 1.562 | 1.605 | 1.607 | 1.610 | 1.602 |
| layer (25° C.) | | | | | |

* photoinitiator: 2,4,6-trimethylbenzoyl diphenol phosphine oxide

As can be seen in Tables 1 and 2 above, the results of measuring the refractive indices of the compositions and the cured coating layers for Examples 1 to 6 and Comparative Example 1 revealed that the compositions comprising the organometallic compounds represented by formulas 1 and 2 can provide prism sheets having the desired high refractive index.

Also, as can be seen in Table 3 above, the results of measuring the refractive indices of the compositions and the cured coating layers for Examples 7 to 10 and Comparative Example 2 revealed that the compositions comprising the organic/inorganic composite represented by formula 3 can provide a prism sheet having the desired high refractive index.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A photopolymerizable composition comprising one or more of organometallic compounds represented by the following formulas 1 and 2: 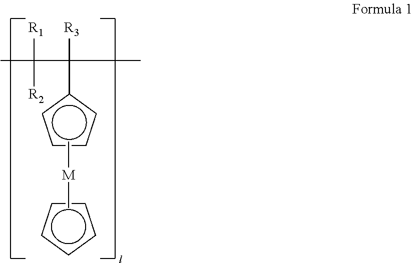
wherein R₁ to R₃ are the same or different and represent a hydrogen atom or an alkyl group having 1 to 15 carbon atoms, M is a metal atom selected from the group consisting of Fe, Mn, Sn, Ti, Si, Cr and Co, and 1 is an integer of 2 or more; and 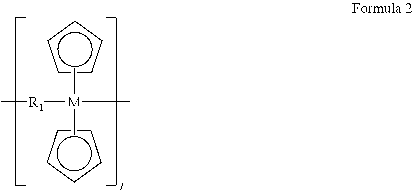
wherein R₁ is an organic group containing at least one atom selected from the group consisting of a hydrogen atom, a carbon atom, an oxygen atom and a nitrogen atom, M is a metal atom selected from the group consisting of Fe, Mn, Sn, Ti, Si, Cr and Co, and 1 is an integer of 2 or more.

2. A photopolymerizable composition comprising an organic/inorganic composite prepared from a metal alkoxide represented by the following formula 3 and an organic compound capable of forming a chemical bond with M of formula 3:
M(OCₙH₂ₙ₊₁)₄ Formula 3
wherein M is a transition metal, and n is an integer ranging from 1 to 1000.

3. The polymerizable composition of claim 2, wherein the organic compound is selected from the group consisting of carboxylic acids, β-ketoesters and β-diketones, which form a chelate bond with the metal ion.

4. The polymerizable composition of claim 2, wherein the organic compound is selected from the group consisting of stearic acid, oleic acid, 10-undecylenic acid, acetoacetoxyethylmethacrylate and allyl acetoacetate.

5. The polymerizable composition of claim 1, wherein the photopolymerizable composition further comprises at least one UV-curable monomer, at least one photoinitiator, and at least one additive.

6. An optical sheet comprising a substrate layer and a cured resin layer formed on one side of the substrate layer, wherein the cured resin layer comprises the photopolymerizable composition of claim 1.

7. The optical sheet of claim 6, wherein the surface of the cured resin layer has a structured shape in which a plurality of three-dimensional structures are linearly or non-linearly arranged.

8. The optical sheet of claim 6, wherein the cured resin layer has a light diffusion layer formed on the surface thereof.

9. The optical sheet of claim 6, wherein the cured resin layer has a refractive index of 1.54 to 2.0.

10. A backlight unit assembly comprising at least one layer consisting of the optical sheet of claim 6.

11. The polymerizable composition of claim 2, wherein the photopolymerizable composition further comprises at least one UV-curable monomer, at least one photoinitiator, and at least one additive.

12. An optical sheet comprising a substrate layer and a cured resin layer formed on one side of the substrate layer, wherein the cured resin layer comprises the photopolymerizable composition of claim 2.

13. The optical sheet of claim 12, wherein the surface of the cured resin layer has a structured shape in which a plurality of three-dimensional structures are linearly or non-linearly arranged.

14. The optical sheet of claim 12, wherein the cured resin layer has a light diffusion layer formed on the surface thereof.

15. The optical sheet of claim 12, wherein the cured resin layer has a refractive index of 1.54 to 2.0.

16. A backlight unit assembly comprising at least one layer consisting of the optical sheet of claim 12.
